(19) United States
(12) Patent Application Publication
(10) Pub. No.: US 2024/0186939 A1
(43) Pub. Date: Jun. 6, 2024

(54) PHOTOVOLTAIC UNIT FOR BODY OF WATER

(71) Applicant: DCH Holding GmbH, 57080 Siegen (DE)

(72) Inventors: Gang Zhang, Siegen (DE); ENNO SCHULTE, Siegen (DE)

(73) Assignee: DCH Holding GmbH, 57080 Siegen (DE)

(21) Appl. No.: 18/285,043

(22) PCT Filed: Mar. 29, 2022
(86) PCT No.: PCT/EP2022/058217

§ 371 Date: Sep. 29, 2023

(30) Foreign Application Priority Data
Mar. 30, 2021 (DE) 10 2021 108 107.6

(51) Int. Cl. H02S 20/30; B63B 35/44

(52) U.S. Cl. CPC H02S 20/30; B63B 35/44; B63B 2035/4453

(57) ABSTRACT

A PV unit for use on a body of water includes a module array including at least one PV module and an array holder designed to move the module array between an operating position on a surface of the body of water and a submerged position below the surface of the body of water. The array holder includes fixing means for coupling to a bottom and/or to the surface of the body of water. The module array is movable in a direction relative to the array holder.

The invention relates to a photovoltaic unit for use on bodies of water, in particular on the sea.

In the two decades since 2000, photovoltaic (abbreviated to “PV” in the following) has undergone dramatic refinements worldwide. There is also a trend towards the construction of PV power plants on inland waterways and in the maritime sector.

EP 3 845 826 A1 describes e.g. a floating structure with solar modules, which can be changed to optimize solar radiation in the azimuth angle, with the solar modules being able to be lowered below the water surface. Furthermore, it is known from WO 2010/026542 A1 to arrange solar modules on inland waters just below the water surface in order to increase their efficiency.

Against this background, it was the object of the present invention to provide means for the efficient and safe operation of photovoltaic units, in particular on maritime bodies of water.

This object is attained by a PV unit according to claim 1 as well as by a method according to claim 13. Advantageous configurations are set forth in the subclaims.

Insofar as numerical values are given for parameters in the following description, these are generally to be understood as approximate information, so that typically numerical values in a range of #25% are also meant. When naming gradations of preferred parameter values, all intermediate values are also implicitly mentioned.

The PV unit according to the invention should be usable in particular for use on bodies of water such as inland lakes or, above all, the sea. It is used to generate electrical energy from incident sunlight, with this energy typically being used or stored by an on-site consumer or a distant consumer, in particular on land. The PV Unit includes the following two components:
A module array with at least one PV module.
An array holder, which is designed to be able to move the module array between an operating position on the surface of the body of water and (at least) a submerged position below the surface of the body of water.

As usual, the term “PV module” refers to the smallest structurally coherent unit with means for converting incident light energy into electrical energy. The geometric shape of the PV module is basically arbitrary. Typically, a PV module is formed essentially flat with a planar or curved (e.g., convex) surface and has an area in the order of one to several square meters.

In the simplest case, the “module array” can comprise of a single PV module. In general, however, it includes several PV modules which are coupled to one another via rigid or flexible mechanical and typically also electrical connections. The module array preferably includes rigid PV modules (or PV units made up of several PV modules) which are flexibly coupled to one another and which have essentially fixed distances from one another. Furthermore, the module array typically includes a connection or an interface via which electrical energy generated by the PV modules can be tapped. At this interface, for example, a rechargeable battery and/or another consumer of electrical energy and/or a cable leading to shore can be connected.

In the “operating position”, the module array should be on the surface of the body of water, which by definition means that the at least one PV module is in a position in which it can produce electrical energy when exposed to solar radiation. Typically, the sensitive surface of the PV module is above the water surface. However, it can also be located slightly below the water surface if this does not significantly affect the light absorption.

The “submerged position” is at a depth below the surface of the body of water that is determined depending on the application. In an important application, the submerged position serves as a “protective position” and is characterized in that a module array located there is so far removed from the influences of wind and/or waves that no damage is to be feared. Typically, the submerged position or the protective position is at a depth that corresponds to one or multiple times the prevailing wave height. In addition or as an alternative, the submerged position or the protective position can also be characterized via the wavelength, i.e. the horizontal distance between two wave crests. For example, the protective position can be assumed to be at a depth of approx. 10%, approx. 20%, approx. 30%, approx. 40%, approx. 50%, approx. 60%, approx. 70%, approx. 80%, approx. 90%, approx. 100%, approx. 120%, approx. 150%, approx. 200% or more of the prevailing wavelength. Furthermore, in addition or as an alternative, the submerged position or the protective position can be situated at a depth at which the mean or maximum flow speed of the surrounding water amounts to less than approx. 10 m/s, less than approx. 5 m/s, less than approx. 2 m/s, less than approx. 1 m/s, less than approx. 0.5 m/s, less than approx. 0.25 m/s, less than approx. 0.1 m/s, or less than approx. 0.05 m/s. Typical absolute numerical values for the protection position are approx. 5 m, approx. 10 m, approx. 15 m, approx. 20 m, approx. 30 m, approx. 40 m, approx. 50 m, approx. 60 m, approx. 70 m, approx. 80 m, approx. 100 m, approx. 150 m, approx. 200 m or more than 200 m below the water surface.

In another application, the submerged position serves as a “cleaning position”, which is characterized in that the surface of the PV modules is flushed and cleaned in this position by the water. The cleaning position is usually relatively close to the surface of the body of water, for example in a range of up to 1 m below the level of the troughs of the prevailing waves. In particular, it can be above the depths mentioned above as examples for the protective position, for example at approx. 0%, approx. 5%, approx. 10%, approx. 30%, approx. 50%, or approx. 75% of the protective position (measured from the water surface).

A further conceivable application can reside in that the electricity production is to be interrupted or reduced by the incident sunlight and the PV modules are to be lowered into a submerged position in which a correspondingly high proportion of the sunlight is absorbed by the water. Furthermore, a lowering into a submerged position can also take place for cooling purposes, for maintenance purposes, for traffic reasons (ship passage) or the like.

As explained, the exact location of the submerged position can vary within a wide range depending on the application and environmental conditions. Typically, it can be approx. 5 m, approx. 10 m, approx. 15 m, approx. 20 m, approx. 30 m, approx. 40 m, approx. 50 m, approx. 60 m, approx. 70 m, approx. 80 m, approx. 100 m, approx. 150 m, approx. 200 m or more than 200 m below the water surface. Of course, any intermediate values for the depths mentioned can also be assumed, and there can also be several submerged positions, which can be assumed depending on the situation (weather, time of day, etc.).

The PV unit according to the invention has the advantage that it can also be operated safely and efficiently on open bodies of water, since its PV modules can be moved if need be to a suitable submerged position below the surface of the body of water, for example for protection or cleaning.

In principle, the entire PV unit could be a floating structure, which can be dynamically positioned horizontally in the desired manner, for example by drives. According to the invention, the array holder is then equipped with fixing means for direct or indirect coupling to the ground and/or to the surface of the body of water. The array holder can be coupled to a point or at least an area (surface of the body of water) by the fixing means, so that in this sense it is fixed in a fixed bearing or at least a floating bearing. The ground may involve the bottom of water or also ground on land. The fixing means can be coupled directly to the ground (e.g. anchors and/or weights and/or poles), but also indirectly, for example via suitable fixed points which are in turn connected to the ground (e.g. artificial islands, offshore structures, fish farms). In this embodiment, the module array is typically coupled to the array holder in a variable position, so that it can be moved between the operating position and a submerged position below the surface of the body of water. Otherwise, shape and configuration of the array holder is arbitrary within wide limits. In particular, it can be a net-like structure with flexible traction means, for example ropes or chains, and/or with rigid connections, for example by rods. Advantageously, the net-like structure can include strands running vertically or obliquely from top to bottom (which typically couple to the ground and/or the surface of the body of water) which are coupled to one another by strands running essentially horizontally on one or more horizontal planes.

In addition or as an alternative, the fixing means can also be designed to be coupled to a flying object such as a balloon for example.

In particular, the array holder can be fixed at at least one point on the bottom of the body of water or at another suitable fixed point. Preferably, it is fixed to the bottom of the body of water at two, three, four or more points. In particular, fixation points can be arranged along the periphery of the array holder, as seen in a vertical projection, so that the array holder is held in a substantially fixed (horizontal) position between them. The fixation of the array holder to the bottom of the body of water may be implemented, for example, via weights and/or ground anchors and/or poles connected to the array holder. The term “fixation” therefore does not necessarily mean a one-piece connection with the bottom of the body of water. Rather, a connection to a point on the bottom of the body of water is sufficient, which connection is fixed under the force loads that typically occur. As already mentioned, the array holder can be formed internally in a net-like manner essentially by means of rigid and/or flexible connections. The structure is preferably designed in such a way that the couplings can be formed solely by flexible but tensile elements such as ropes or chains. Furthermore, the array holder can include, in particular, vertical, rigid structures such as poles for example, along which the module array can be moved, e.g. in the same way as on the cylinder buoys described later.

The array holder preferably includes at least one buoyancy body, i.e. a body which generates in the water buoyancy which is directed towards the water surface. Such a buoyancy body makes it possible to exert forces on the array holder that are directed toward the surface of the body of water in order to keep it in a specific configuration. For example, the array holder can be attached via a buoyancy body to the level of the surface of the body of water in the sense of a floating bearing. When the PV unit is installed, the buoyancy body can be on the surface of the body of water and protrude from the water, but it can also be completely submerged in the body of water.

The module array is further coupled to the array holder such as to be movable relative thereto, that is at least (or exclusively) in one direction. When the PV unit is installed, this direction is typically vertical, so that the module array can only be moved in the vertical direction relative to the array holder for example, whereas its horizontal position is essentially fixed. The array holder fixed to the bottom of the body of water and/or to the surface of the body of water then forms virtually a frame along which the module array can move in order to switch between the operating position and the submerged position.

When shifting the module array from the operating position to the submerged position, the array holder will typically remain stationary relative to the environment (seabed, etc.) while the module array is moving. Optionally, however, a (co-)movement of the array holder may also take place at least partially. Furthermore, it is conceivable that the array holder can be moved and/or changed in shape overall, for example can be lowered in the direction of the bottom of the body of water.

Various advantageous refinements of the PV unit are described hereinafter, which can be implemented individually or in any combination with one another.

According to a refinement, the coupling between module array and array holder is designed in such a way that the module array can only be moved up to a stop position in relation to the array holder. Optionally, each of both directions of movement may hereby be limited by a stop position. A stop position can be provided in particular for the downward movement of the module array directed towards the bottom of the body of water in order to keep it at a specific water depth and to prevent it from sinking completely to the bottom of the body of water. Provision is advantageously made also for a stop position for the upward movement directed towards the surface of the body of water, for example to prevent the array holder from becoming detached from the module array and/or in order to achieve coupling properties defined in the region of the surface of the body of water between array holder and module array, which coupling properties have an influence upon the overall dynamic behavior of the PV unit.

The module array preferably includes (at least) one buoyancy body or is coupled to at least one buoyancy body. In this way, it is possible to exert a force directed towards the surface of the body of water upon the module array in order to hold it in the operating position on the surface of the body of water, for example. Closed hollow chambers filled with air, for example, are suitable as buoyancy bodies.

In addition or as an alternative, the module array and/or the array holder can include (at least) one downforce body with variable downforce or be coupled thereto. A “downforce body” is hereby to be understood as a component which can exert a downforce, i.e. a force directed towards the bottom of the body of water. Due to the variability of the downforce, the strength of the downforce can be controlled. The downforce is preferably between a maximum value and a value of or close to zero, with the latter corresponding to a body floating in the water. Optionally, the downforce can also be lowered up to negative values, i.e. switch to buoyancy in direction of the surface of the body of water. The downforce can be generated in particular by the weight of the downforce body, with its size resulting from the difference between the own weight of the downforce body, with the magnitude thereof governed according to Archimedes' principle from the difference between the weight of the displaced water volume and the weight of the downforce body. Such a variation in the downforce can be implemented in a simple manner by the controlled filling of a cavity with a light gas such as air or hydrogen (H₂).

Furthermore, in addition or as an alternative, the module array and/or the array holder can include (at least) one buoyancy body with variable buoyancy or be coupled thereto. The technical implementation thereof can be realized analogous to the downforce body described above with variable downforce.

Viewed in general, the entire module array forms with the included PV modules, connections, buoyancy bodies, downforce bodies, etc. a unit which may have a certain positive buoyancy or negative buoyancy (i.e. downforce) overall in water. This whole buoyancy should ultimately be adjusted such as to be positive (directed toward the surface of the body of water) for assuming the operating position and negative (directed toward the bottom of the body of water) for assuming the submerged position. Such a regulation can be achieved, for example, via downforce bodies and/or buoyancy bodies with variable buoyancy.

It has already been mentioned that, in the simplest case, the module array can be comprised of a single PV module. However, the module array preferably incudes two or more PV modules which are coupled flexibly and/or at a (minimum) distance to each other. In particular, several PV modules can be coupled rigidly and/or flexibly to form PV elements, which in turn are flexibly connected to form the module array.

In a further embodiment of the invention, the array holder includes at least one essentially vertically running guide element, with which the module array is movably coupled (preferably linearly mobile). The module array can then be moved along the guide element in a defined manner and on a defined path. There are preferably several such guide elements, which are arranged distributed in the horizontal plane, typically extend over approximately the same water depth, and along which the module array is guided when it moves relative to the array holder. In particular, such guide elements can be arranged at intervals along the periphery of the module array. Furthermore, in preferred embodiments, the guide elements can protrude vertically upwards from a base of the array holder, which base is anchored to the bottom of the body of water. The guide elements can be rigid bodies, which are held in their vertical orientation by appropriate devices (traction means, rods, etc.). In addition or as an alternative, the guide elements can include buoyancy bodies, which effect their alignment and positioning in the water. According to a further embodiment, the guide elements can be rigid poles, rods or the like, which are fastened in or on the ground.

In a refinement of the invention, the aforementioned guide element includes a movably mounted running unit to which the module array is (in particular detachably) connected or connectable. The movement of the running unit along the remainder of the guide element can then be designed in a defined manner, for example via appropriate roller bearings, heavy-duty rollers, or plastic slide rails. The running unit is preferably essentially linearly mobile and/or optionally non-rotatable with respect to the axis of the guide element or limited in terms of the rotational mobility. In particular, over-rotation of the running unit can be structurally excluded, for example a multiple rotation around the axis of the guide element.

According to another refinement of the invention, the mobility of the module array in relation to the array holder is variable, preferably adjustable. In principle, the variability can cover the entire spectrum between “freely mobile” and “locked in a certain position” or a sub-interval thereof (with “free mobility” to be understood practically and can include e.g. unavoidable friction). A reduction in mobility can be used, for example, to reduce the speed of movement of the module array and thus reduce the force loads in the PV unit. In particular, the movement of the module array in the downward direction or upward direction can be slowed down when approaching one of the afore-mentioned stop positions. A complete suspension of mobility (locking) can be used to hold the module array in a desired submerged position if need be and depending on the situation (e.g. depending on the strength of the swell).

The described variability of the mobility of the module array in relation to the array holder can, for example, involve, when designing (constructing) a PV unit for the application (inland water, bay, open sea, etc.) that a suitable mobility is defined and, for example, implemented constructively (by defining certain distances, tightening screws, pretensioning spring elements, which, e.g., press slide rails upon sliding surfaces and thereby generate a defined frictional force, etc.). This mobility can then remain unchanged with the installed PV unit. The variability of the mobility can additionally or alternatively also involve a time, location and/or speed dependency of the mobility. This can be implemented constructively, for example, by increasing the friction in certain movement sections, Optionally, mobility can also be actively controlled by appropriate mechanical, hydraulic, electrical or other actively actuatable devices such as friction brakes for example. Corresponding actuators can be controlled, for example, using a central control unit on the PV unit and/or via a remote connection.

The “mobility” can be described quantitatively, for example, by the dynamic behavior of a long cylinder buoy (see Figures) when a force F acts on the module array. When x is the position of a point of the module array (e.g. along a guide of the long cylinder buoy (coupling point of the module array with the running unit of the long cylinder buoy described later)), the following equation of motion can apply for the long cylinder buoy along its vertical axis:

\ddot{x}=a*F(t)+b*x+c*\dot{x}

The parameters a, b, c can hereby be constants or dependent on time t, location x and/or speed \dot{x}, wherein a time dependency would reflect, for example, an explicit external control. The parameters ascertain dynamic processes such as friction, attenuation, spring behavior, elasticity, etc. The parameter a includes the information about the amplitude of the acting force F. The parameter b includes the information about the hydrostatic stiffness of the long cylinder buoy. The parameter c includes the information of the attenuation intensity. Through appropriate adjustment of these parameters, the overall hydroelastic behavior of the PV unit can be optimized with respect to the impact of waves.

The buoyancy body included in the array holder can in particular have an elongated shape, which can be roughly described preferably by a cylinder or a spindle (cylindrical shape pointed at the ends). The ratio of width to length of the buoyancy body is less than one (100%). It can preferably have a maximum value of 1:2 (corresponding to 50%), furthermore preferably a maximum of one of the values 40%, 30%, 20%, 10%, 5%, 2.5%, 2%, 1.5%, 1%, 0.5%, 0.1%, 0.05%, 0.01% or less. The elongated shape supports a stable position of the buoyancy body in the water. The longitudinal extension can hereby in particular be aligned vertically. It is hereby also advantageous that the buoyancy body can extend into deep, relatively calm water zones and as a result is additionally stabilized. The absolute length of the buoyancy body is preferably at least 1 m, particularly preferably at least 2 m, 3 m, 4 m, 5 m, 6 m, 8 m, 10 m, 15 m, 20 m, 25 m, 30 m, 35 m, 40 m, 45 m, 50 m, 55 m, 60 m, 65 m, 70 m, 80 m, 85 m, 90 m, 95 m, 100 m, 120 m, 150 m, 200 m or more.

As already mentioned, the buoyancy body can be designed in particular to assume a vertical orientation in the water. For this purpose, its density varies, for example, along its length extension, so that in the water a lower-density head area is arranged over a higher-density foot area. In particular, a weight with a higher density than that of water can be arranged in the foot area of the buoyancy body.

According to another refinement, the module array can be movable along the buoyancy body of the array holder. This applies in particular when the buoyancy body is aligned vertically in the water with a longitudinal extension as described above. The buoyancy body then represents an example of a guide element of the afore-described type. The coupling of the module array to the buoyancy body is preferably designed as a linearly movable bearing. For example, an eyelet of the module array can include a rod-shaped buoyancy body. As already mentioned, the buoyancy body can also include a mobile running unit to which the module array can be coupled. Various embodiments will be explained in more detail later in conjunction with the Figures.

The buoyancy body of the array holder can also have a damping element for damping its movement in the water. The damping element can be designed, for example, as a (closed or perforated) plate or disk which generates a high flow resistance perpendicular to its surface and as a result dampens movements in this direction. In particular, the damping element can be located on the buoyancy body in such a way that its upward and downward movements in the water are reduced. The damping element is also preferably located in a region of the buoyancy body which, in the operating state, is at a distance from the water surface or in relatively calm water layers.

At least one buoyancy body of the array holder can be designed to assume a position below the surface of the body of water (i.e. to be completely submerged) in the operating state of the PV unit. In particular, a position can be involved which lies in the area of the submerged position or below. Such a buoyancy body ensures that lower-lying parts of the array holder are correctly aligned or assume a certain distance from the bottom of the water.

According to a further embodiment, at least one fixing means, which is provided for coupling to the bottom and/or to the surface of the body of water, can lie outside the area of the module array, as seen in the vertical direction (projection). In this way, horizontal forces from currents, waves, wind and the like can be absorbed and the horizontal position of the module array can be fixed. It is particularly preferred when several fixing means are dispersed around the module array and project outwards in order to be able to absorb forces from different directions.

The described PV unit can be dimensioned depending on the application and requirements. It typically includes approx. 100-2000 conventional solar modules or a maximum energy production of approx. 0.5-2 MWp.

Structurally, the PV unit is usually a self-contained system that can be installed in a body of water. Optionally, however, several PV units can also be coupled to form large-sized PV power plants by being distributed over an area and preferably coupled to one another by horizontal connections.

Typically, the module array of a PV unit is shiftable overall only as a unit between the operating position and a submerged position. In the case of the afore-described PV power plants, however, the module arrays of the individual PV units can optionally be shifted independently of one another. Depending on the situation, this makes it possible to lower the module arrays differently, for example more so along the edge of the PV power plant than in midsection.

The invention further relates to a method for operating a PV unit on a body of water, with the PV unit including a module array with at least one PV module. The method is characterized in that the module array can be shifted depending on the situation between an operating position on the surface of the body of water and a submerged position below the surface of the body of water.

The method can be carried out in particular with a PV unit according to one of the afore-described embodiments. Therefore, the explanations given for the PV unit also apply to the method and vice versa, even if this is not specifically mentioned below.

According to a preferred embodiment of the method, the module array is shifted to the submerged position (“protected position”) when swell and/or storm exceeds a given strength, with this swell and/or storm already existing or only being predicted. The shift can be initiated via the control by a user. In particular, however, it can also be implemented automatically as a function of the measured values from sensors for swell and/or storm or as a function of weather forecasts.

In addition or as an alternative, a shift into the submerged position (“cleaning position”) can also take place for cleaning purposes. Such a shift can, for example, take place automatically at regular intervals and/or when the efficiency of the modules has fallen below a predetermined value due to salt and/or dirt deposits.

According to another option, the shift to the submerged position can take place when, for certain reasons (e.g. malfunction of the system), the electricity production is to be interrupted or reduced.

Finally, the submerged position can also be approached when the solar radiation (e.g. at night) is below a defined minimum value and the modules (e.g. for safety reasons) are better positioned under water than on the surface of the body of water.

The shift of the module array can be realized in different ways. For example, traction means fixed to the bottom of the body of water could forcibly pull a module array designed with buoyancy below the surface of the body of water. In a preferred embodiment, however, the shift is implemented through a change in the buoyancy and/or downforce of the module array and/or of at least one body coupled to the module array. In other words, the state of the module array can be varied between “floating”, “hovering” and “sinking”.

Since the PV unit according to the invention is comprised of two separate components, namely the module array on the one hand and the array holder on the other hand, these represent independently marketable components. The scope of protection of the invention therefore also includes module arrays which are suitable for a PV unit according to one of the above embodiments, as well as array holders which are suitable for a PV unit according to one of the afore-described embodiments.

Likewise, the buoyancy bodies according to the afore-described embodiments can involve independently marketable components and thus independent aspects of the invention.

The invention will be explained in more detail hereinafter with reference to the Figures using exemplary embodiments. It is shown in:

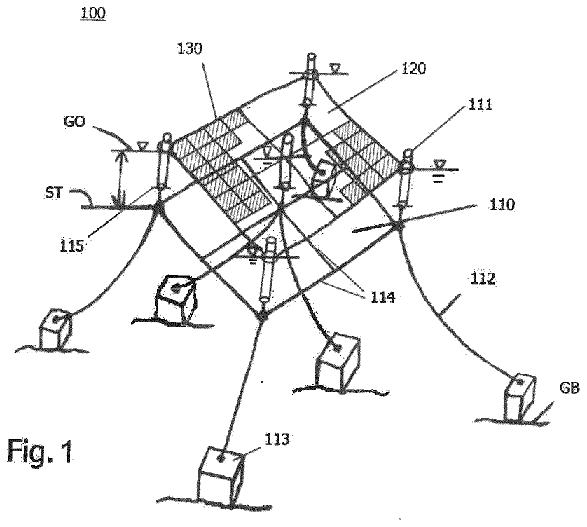

FIG. 1 a schematic perspective overall view of an installed PV unit;

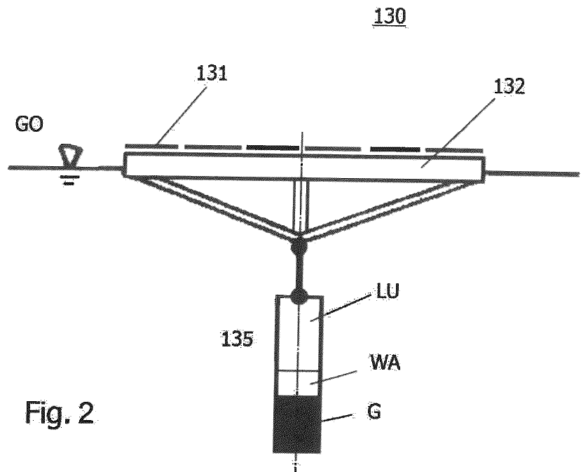

FIG. 2 the side view of a single PV element with attached downforce body;

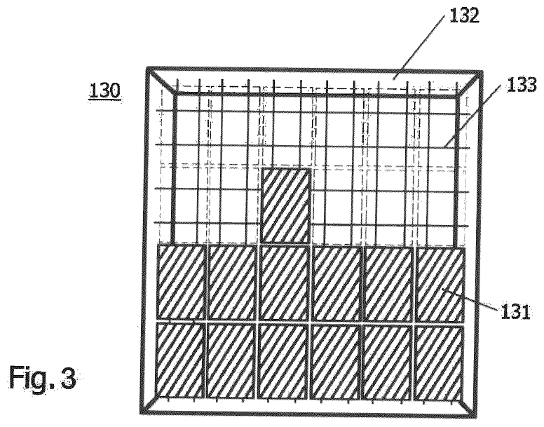

FIG. 3 a plan view of the PV element of FIG. 2;

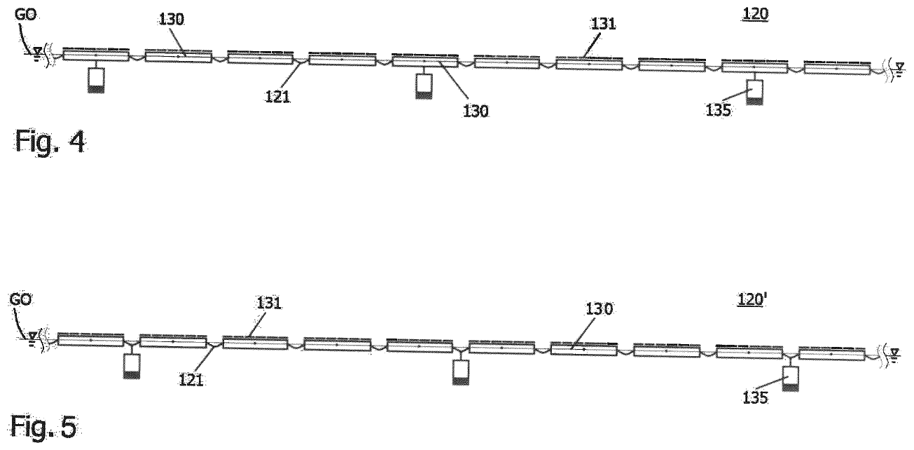

FIG. 4 a side view of a module array with downforce bodies attached to the PV elements;

FIG. 5 a side view of a module array with downforce bodies attached between the PV elements;

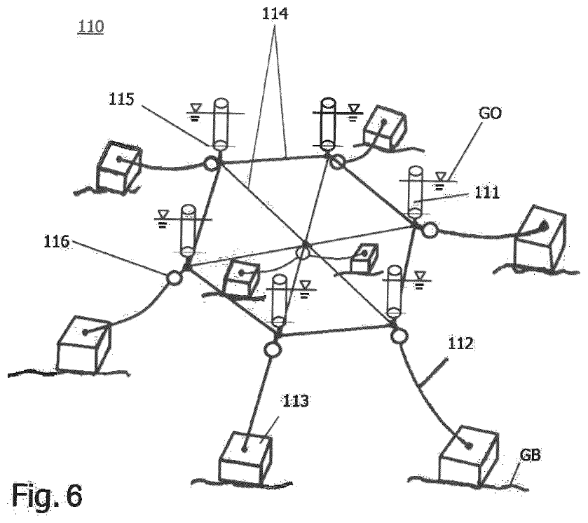

FIG. 6 a separate perspective view of an installed array holder;

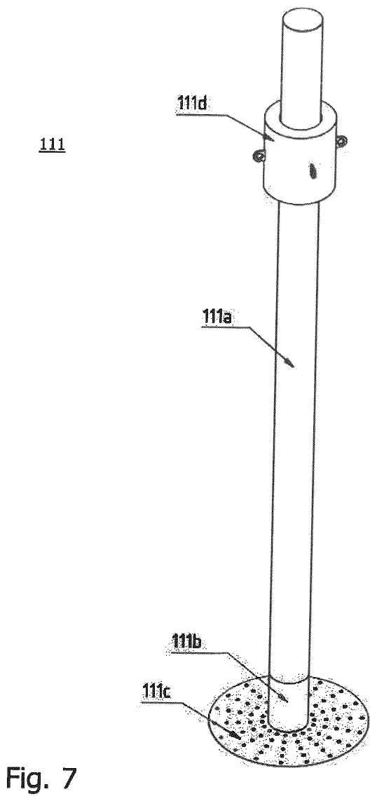

FIG. 7 a perspective view of an elongated buoyancy body (position buoy) with vertically acting damping element and a cylindrical running unit;

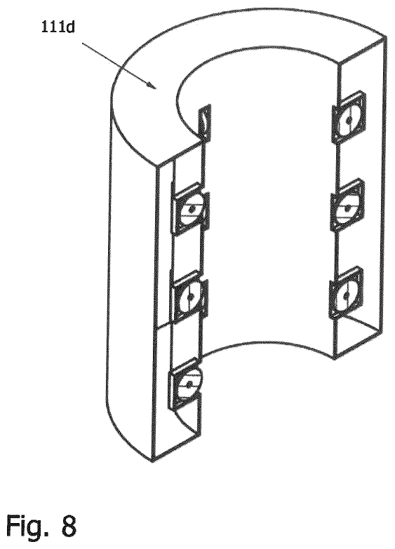

FIG. 8 a section through the running unit of FIG. 7;

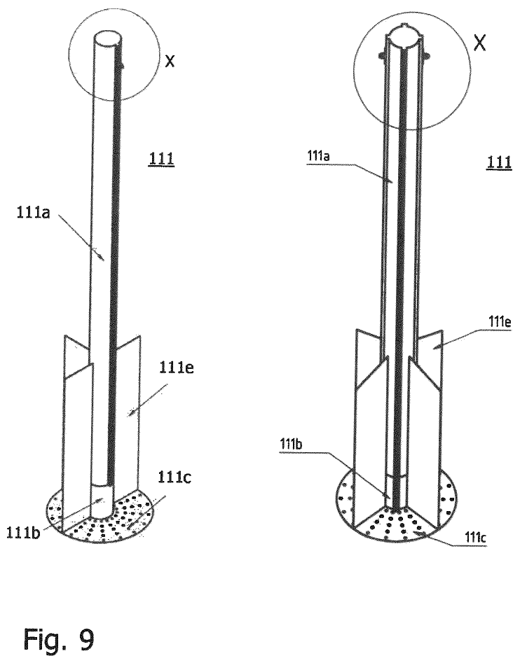

FIG. 9 a perspective view of two embodiments of an elongated buoyancy body with vertically acting and horizontally acting damping elements and a running unit in a linear guide;

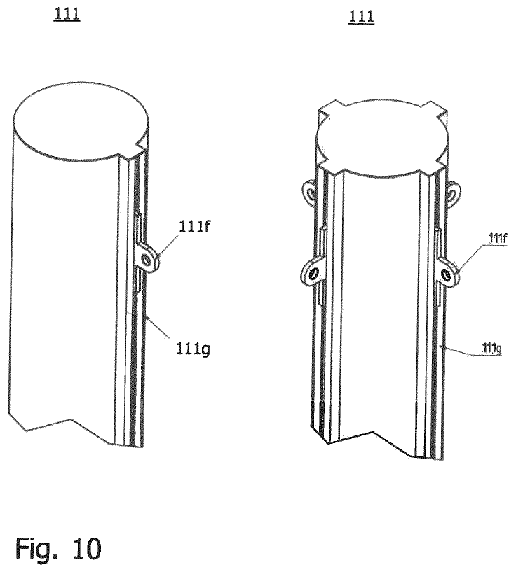

FIG. 10 a detailed view of the head area of the buoyancy body of FIG. 9;

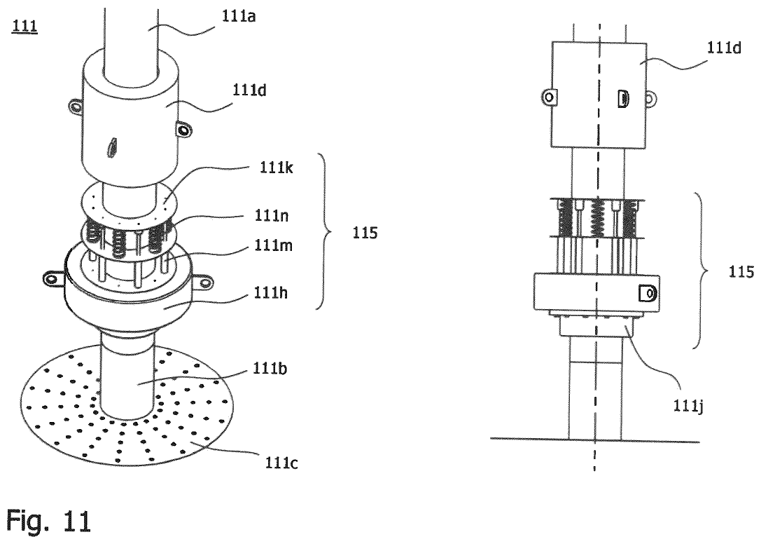

FIG. 11 a detailed view of an example of the foot area of an elongated buoyancy body with a buffered stop position, buoy holder and locking unit in a perspective (left) and a side view (right);

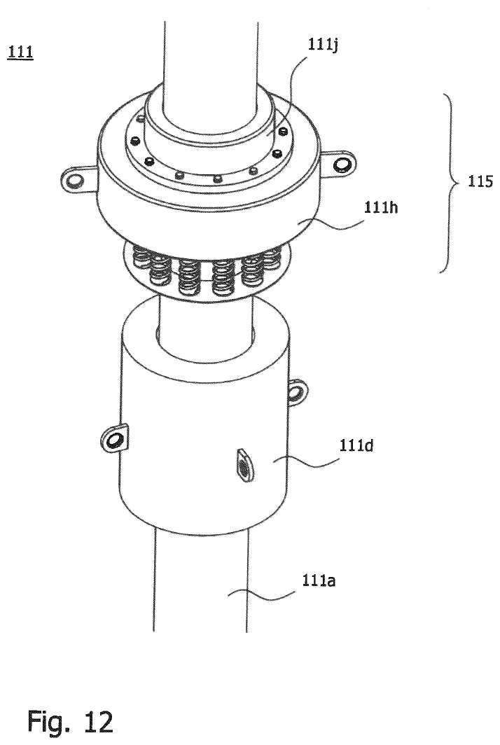

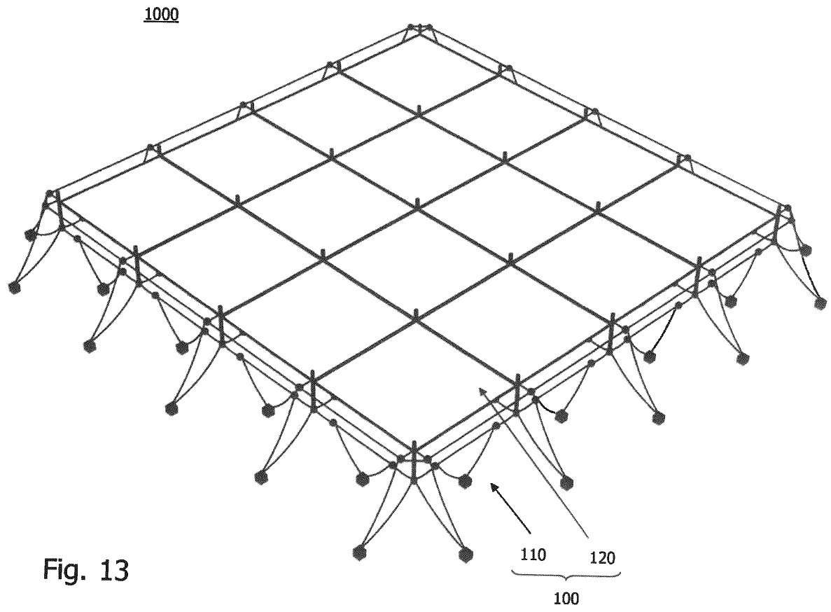

FIG. 12 a detailed view of an example of the upper region of an elongated buoyancy body with buoy holder and locking unit;

FIG. 13 the overall view of a PV power plant constructed from a plurality of PV units;

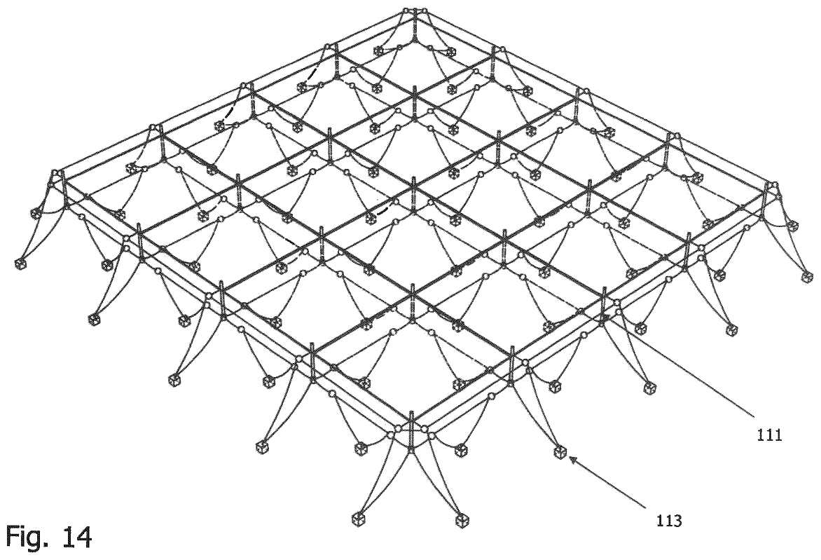

FIG. 14 the PV power plant of FIG. 13 without PV modules and PV elements;

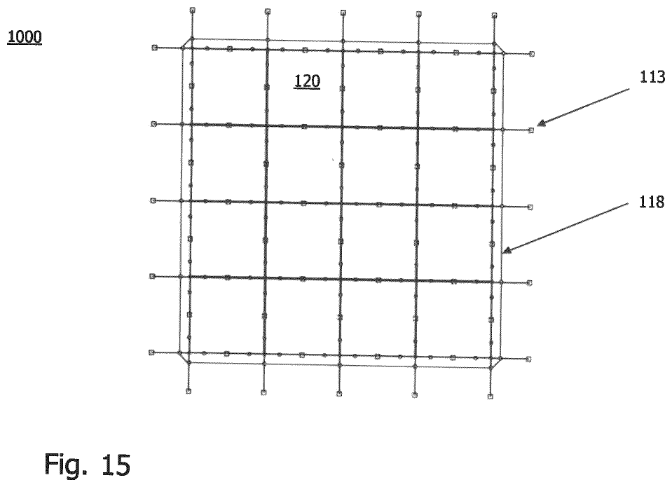

FIG. 15 a plan view of the PV power plant of FIG. 13;

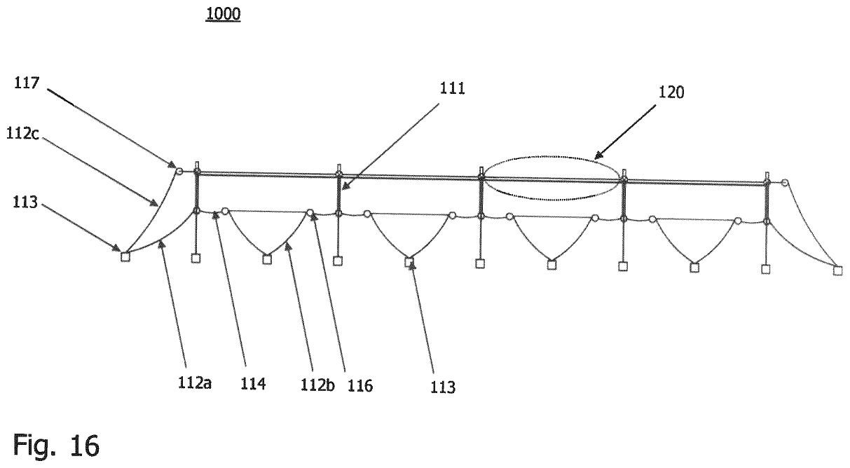

FIG. 16 a side view of the PV power plant of FIG. 13.

The embodiment of the invention described in the Figures represents a largely flexible structure with lowest possible flow resistances, which structure moreover is characterized by the possibility of vertical lowering of essential functional components that could be destroyed by very strong winds and very high waves on the sea surface. The embodiment relates to small and large maritime photovoltaic power plants (PV power plants). Photovoltaic power plants of this type can of course also be operated in inland lakes and sheltered bays. The features mentioned in the examples can always be implemented separately and independently of the other features of the illustrated exemplary embodiments.

PV power plants can be modularly constructed from an appropriate grouping of photovoltaic (PV) units. A PV unit 100 can, for example, have a size of one megawatt peak (1 MWp) and can be comprised, for example, of one hundred PV elements 130, each with a power output of ten kilowatts peak (10 kWp). PV elements 130 may have a rigid or at least partially flexible frame with certain buoyancy in conjunction with an adjustable downforce. The smallest unit of the photovoltaic energy generation is the individual PV module 131. The PV modules are positioned on the PV elements 130 in a suitable manner and number.

For better explanation, the following descriptions relate primarily to a single PV unit 100. The development described here solves the problem of excessive mechanical stresses on the PV units, i.a. as a result of swell, with a new conceptual approach and specific design details.

Up to a certain swell (maximum operating swell), the individual PV elements 130 are located at a suitable intended height on the water surface GO, so that the PV modules 131 are situated at the optimum height above the water surface. The PV elements 130 are elastically connected to each other with ropes and/or spacers (121 in FIGS. 4, 5) to form a module array 120 such that they have a defined distance from one another in the case of a calm and level sea surface and the sum of the PV elements forms the basic shape of the PV element area that is situated on the sea surface (e.g. a square array).

In principle, as the swell increases, the PV elements 130 follow the wave movement up to a limit, the maximum operating swell. When the current swell exceeds the maximum operating swell, or if, according to the weather forecast, it is expected to be exceeded within a short period of time, the PV elements 130 of the PV unit 100 are lowered in their entirety below the water surface and thus removed from the sphere of influence of the wave movement of the water surface. Pressure fluctuations induced by the waves on the water surface and, i.a., oscillating water movements decrease sharply with the water depth. As of a suitable water depth, the influence of the water at depth by the dynamic processes on the water surface is so small that the PV elements 130 lowered there experience only a small dynamic load. The necessary sinking depth is the water depth suitable for the PV elements, defined here as “protection depth ST”, in which the dynamic forces and water movements of the waves on the water surface and additional flow forces have dropped to a permanently tolerable low level. The protection depth ST is a representative example of a general “submerged position”, up to which the PV modules can be lowered for various reasons (e.g. for cleaning purposes).

Additional flow forces are also created by other seawater currents, e.g. by the tides, but also by other regional and national water currents. These currents will be primarily parallel to the horizontal plane of the PV elements 130 and must be accounted for as one of the encountered stresses by the design.

For the lowering process, the buoyancy of the PV elements 130 is reduced to such an extent that they sink. Basically, there is the problem of limiting the sinking to a certain depth, because once a body sinks under water, it always sinks to the bottom. In the present case, the sinking depth is limited and defined in a simple and hitherto unknown manner by creating in the defined protection depth ST vertical limits 115 (FIG. 1, “stop position”) which stop the further sinking of the PV elements 130 in the protection depth. The vertical limits are connected with suitable connecting means to, e.g., the position buoys 111 explained later, which carry the weight of the lowered PV elements. Buoys can also be positioned under water at a suitable location, preferably at the level of the protection depth ST or below (e.g. stabilization buoys 116, FIGS. 6, 16). The PV elements 130 stop sinking when they are prevented from sinking further by the vertical limits 115. In this case, the structure A called “array holder 110” with its position buoys 111, for example, absorbs the vertical load of structure B (“module array 120” made of PV units 130). Optionally, the downforce of the PV units 130 could also be reduced at or near the hover point at the depth of protection.

The sinking process of the module array 120 can additionally or alternatively also be stopped or slowed down by downwardly suspended weights (not shown) which are attached to the module array and rest on the bottom of the water at a suitably adjusted depth and thus no longer exert any tractive force.

A possible embodiment variant of a PV unit 100 is described for further explanation. In principle, the PV unit can advantageously be broken down roughly into two interconnected function macrostructures.

Structure A, also called “array holder” 110, is the positioning structure for the entire PV unit (FIG. 1). In principle, it is comprised of traction means, position buoys (and, optionally, further buoyancy bodies), mechanical couplings and suitable attachment points. Offshore wind turbines, structures of fish farms, oil rigs and any other suitable structures can also be used as position buoys and/or attachment points. Structure A forms a horizontal boundary for the PV elements 130 on the sea surface GO (working position) and at a defined protection depth ST (submerged position). For this purpose, the structure A has connections to the seabed GB and/or to the mainland and/or other fixed points in order to position the positioning buoys 111 with a suitable accuracy at a horizontal position of the sea. The connections to the seabed can be made with traction means 112, e.g. with ropes, chains or rods. The traction means are fastened to the seabed, e.g. to suitably dimensioned weights 113 (e.g. concrete bodies), which are positioned on the seabed, or to other fixed points.

Structure B is a module array 120 comprised of the PV elements 130. Structure B (module array 120) is held by structure A (array holder 110) in the desired described positions (working position, submerged position). The PV elements 130 have a variable buoyancy that is e.g. controlled centrally (for example in a control unit, not shown, on the array holder or via wireless communication from shore). In the working position, the module array 120 floats independently, the horizontal position is determined by structure A. When the submerged position is to be approached, the buoyancy of the PV elements 130 is reduced to such an extent that the module array 120 sinks from the working position to the submerged position. In the submerged position, structure B, the module array 120, is held by structure A, the array holder 110, in a vertical position (submerged position) and in a horizontal position. For lowering of the module array, for example, all PV elements 130 can per se have a stable horizontal position, so that when the module array is lowered, only minimized force effects (contact and frictional forces, without tilting or tension) occur in the connection points of structure A and structure B and between the individual PV elements.

A PV element 130 (FIG. 2) typically carries several PV modules 131 and is an independently floating module of the module array 120: For example, it is comprised of a firm or at least partially flexible frame 132 of suitable material, e.g. seawater-resistant plastic and/or metal and/or another material with a defined buoyancy and a downforce body 135 below the water surface GO. The downforce body 135 includes a controllable downforce. The center of gravity of a PV element is below the center of buoyancy and thus a stable position of the PV element 130 is ensured. In order to lower the PV element, the downforce is increased until the PV element sinks. For surfacing, the downforce is reduced until the buoyancy from the frame 132 exceeds the downforces and the PV element 130 rises to the water surface.

A downforce body 135 can be seen schematically by way of a section in FIG. 2. It is comprised of a completely closed volume, which is filled with a weight G, with water WA, and with air LU. The proportions of water and air can be changed from the outside in a controllable manner in order to set a desired downforce in the direction of the bottom of the body of water. For this purpose, the downforce body 135 can include a pump (not shown), electrical connections and/or a communication device (for example for sound-based communication).

For the operation of electrical device such as motors, pumps or the like, the PV unit 100 includes the necessary electrical supply lines as well as optionally energy stores (e.g. accumulators, not shown), from which the required electrical energy can be tapped. In addition or as an alternative, some PV modules can also remain permanently on the surface of the body of water and not be lowered to ensure an emergency power supply.

Overall, the individual PV elements 130 should have little buoyancy and the PV modules 131 should be positioned close to the water. The closer the individual PV modules are to the water, the better the efficiency of the PV modules as a result of the cooling effect of the water. The PV modules 131 can, for example, be attached to tensioned ropes 133 which are fastened to the frame 132 of the PV element (FIG. 3). However, the PV modules can also float by themselves and be held in position within the frame, e.g. with ropes. The individual PV modules 131 are fastened and/or provided with elastic spacers in such a way that they do not touch one another.

Not every PV element 130 has to be equipped with a downforce body; as an alternative, it is sufficient when suitable downforce bodies 135 are present only at certain intervals (FIGS. 4, 5). For example, through low buoyancy and the positional stability of each individual PV element 130 and the connection of the PV elements to one another to form a module array 120 (structure B), the module array can also be lowered into the submerged position using just a few downforce bodies. The generated controllable downforce acts hereby on the positions of the downforce bodies 135 and is distributed over the entire module array 120 via the connections 121 (e.g. ropes) of the PV elements 130. For example, a square module array 120 of a PV unit 100 comprised of, e.g., one hundred PV elements 130 (side lengths comprised of ten PV elements each) can be brought into the submerged position in a controlled manner by, for example, nine downforce bodies 135. The downforce bodies 135 can be positioned, e.g., at the corners of the square, in the middle of the long sides and in the center of the square. When sinking, the PV elements 130 connected, for example, with ropes 121 form a slightly upwardly curved shape due to their buoyancy, with the deepest points of the curvatures being the positions of the attack of the downforce of the downforce body 135, respectively. Here, the module array 120 tends to contract horizontally. The curvature is to be limited by suitably weak buoyancy of the individual PV elements and suitably weak downforce of the downforce body such that the horizontal connection forces remain low on the mechanical couplings between the positioning structure 110 (structure A) and the module array 120. Furthermore, as already described, the array holder can be made so stable by its edge structure (in particular by outwardly projecting connections with the bottom of the body of water) that it compensates for the tendency of the module array to contract and it retains its shape regardless of the vertical position of the module array.

The connections between structure A (array holder 110) and structure B (module array 120) are preferably created with specific mechanical couplings which in the working position only prevent the movement of structure B relative to structure A in the horizontal direction. In the submerged position, another degree of freedom, the movement in the vertical direction, is limited downwards by the structure A, as previously described already. Technically, these mechanical couplings can be realized, e.g., by suitable linear guides. For example, rope loops or, for example, elastic or fixed rings can move up and down with suitable play in the horizontal plane around what are in principle straight vertical structures. As vertical structures, for example, the positioning buoys 111 of structure A itself, or linear structures running vertically (e.g. rods, taut ropes, guides, etc.) attached to the positioning buoys can be realized. Thus, the module array 120 can follow the wave movements in the vertical direction to which it is exposed, until the maximum operational swell is reached. The described mechanical couplings may also be attached to offshore wind farms, fish farm structures, oil rigs, or any other suitable structure.

In the submerged position, limits 115 define the sinking depth of the module array 120. The limits 115 can be, e.g., thicker bodies (spheres, rods, supports, stop surfaces, etc., see Figures) over which a guide eyelet of the module array or, for example, a running unit 111d (see below) cannot slip by. The connecting elements described between structure A and structure B rest on the limits and introduce the weight forces of the module array 120 of structure B in the submerged position into the structure A (array holder 110). The position buoys 11 of the structure A now absorb the additional weight from structure B.

In principle, structure A of a PV unit 100 must, i.a., have sufficient positional stability so that it holds structure B, the module array, in position in a sufficient manner and provides a sufficiently stable vertical limit for the structure B in the submerged position. For this purpose, the alignment of the traction means 112, which connect the weights 113 on the seabed/or other suitable fixed points, e.g. with the position buoys 111 of structure A, must be carried out in such a way that structure A forms an array, which can guide or position the structure B in the manner described. For this purpose, for example, the weights 113 can be positioned at a suitable horizontal distance around the formed array of structure A on the seabed, so that tensile forces in the traction means cause vertical forces only to an extent that can be compensated for by the buoyancy of the positioning buoys 111. Traction means can also be attached to position buoys 111 inside and on the longitudinal sides of the formed array in order to strengthen the connection to the ground or the weights 113 on the ground/or suitable fixed points.

As can be seen from FIG. 1, the weights 113 for coupling to the bottom protrude radially outwards in all directions from a vertical projection of the area of the module array 120 on the seabed.

The upper end of the positioning buoys 111, which end lies on the surface of the body of water, can also optionally be coupled to the bottom of the body of water via traction means (FIGS. 13, 14, 16). In this way, a contraction of the module array (area reduction) can be prevented by a radial outward pull. Such traction means are preferably routed via deflection buoys (117, FIG. 16) floating on the surface of the body of water in order to allow essentially only horizontal forces to act on the positioning buoys.

Overall, the forces acting on the PV unit 100 due to wind and swell and other currents are to be minimized. This is achieved by the components of the PV unit offering the smallest possible contact areas for the currents. This can be achieved, for example, by using traction means such as e.g. ropes. The entire PV unit is therefore permeable to currents and offers only little resistance to waves and currents. Furthermore, the entire system is preferably flexible and can deform elastically. As a result, it can give way in the event of selective forces (e.g. breaking waves) and thus keep the stress on the system low. The PV elements 130 can be formed from solid structures in the manner described. The problem of larger contact areas of the PV modules 131 on the PV elements 130 and thus of the PV elements is solved by allowing the module array 120 to sink into the submerged position in the manner described.

In general, the buoyancy of the used buoyancy bodies (e.g. position buoys 111) should be selected as large as necessary (for safe positioning of the PV unit) and as small as possible (to minimize the impact of forces that i.a. affect the system due to swell).

In order to minimize the current forces on the positioning buoys 111, these can have an optimized shape with a specific buoyancy geometry. For example, a position buoy can have an elongated cylindrical shape (optionally also with variable diameters along the vertical axis of the buoy), in the lower region of which a suitably dimensioned weight can be located. However, stability against tilting can also be achieved by attaching fixing means in the lower and/or upper region of the buoy. As a result, the positioning buoys have a high degree of tilting stability and thus enable good horizontal positioning stability for the structure B, the module array.

Furthermore, it is advantageous when the position buoys 111 have a smallest possible change in buoyancy as the immersion depth changes. This is achieved, e.g., by a slender shape (e.g. tube) of the buoy, at least in the area where the waves attack. For example, when a wave passes, the tensile forces on the traction means that hold the buoy in position only increase to a tolerably small extent and the entire structure remains relatively calm.

A further advantage of a suitable buoyancy geometry, e.g. an elongated cylindrical buoy shape, is that the lower parts of the buoy are already in a calm water layer and thus dampen the movement of the entire position buoy. The position buoys can also be completely washed over by water in very high swell. Any other buoyancy geometries are also conceivable, such as, e.g., spherical buoys coupled to one another by traction means, which spherical buoys can be lined up to form a kind of chain. Furthermore, additional buoys (e.g. stabilization buoys 116, FIGS. 6, 16) can be positioned so deep under water that they are unaffected (or only suitably slightly influenced) by the dynamic forces caused by the wave movement so as to ensure uniform buoyancy and can support the described formation of structure A in cooperation with the position buoys.

Preferred embodiments of the positioning buoys 111 are explained in more detail hereinafter with reference to FIGS. 7 to 12.

Due to the wave movement, in addition to i.a. friction and pressure forces on the buoy, there are also inertial forces. These are proportional to the displaced water volume and the water acceleration, directed in direction of the water acceleration.

The cylindrical positioning buoy 111 described here with vertical extension is hereinafter referred to as “long cylindrical buoy” (FIG. 7). It is essentially comprised of a cylindrical, hollow buoy tube 111a, at the base of which a weight 111b is arranged. The ratio of diameter and total length of the buoy (length of the buoy tube 111a+length of the weight 111b) is preferably less than 1:2, particularly preferably less than 1:10. The smaller the ratio of diameter to overall length and the greater the overall length, the smaller the change in buoyancy due to the wave movement on the surface becomes. As a result, the vertical movement of the position buoy 111 becomes smaller compared to the wave movement.

In order to additionally dampen the upward and downward movements of the long cylinder buoy 111, a vertical flow brake in the form of e.g. a (horizontally running) round plate can be attached as a damping element 111c (also several vertical flow brakes on top of one another are conceivable) e.g. to the lower end of the weight 111b. During the upward movement, the vertical brake 111c creates a resistance that opposes the upward movement. Likewise, the vertical flow brake opposes the downward movement of the buoy. Overall, the vertical flow brake acts as a movement-dampening element and reliably prevents resonance vibrations of the buoy.

In order to create favorable flow conditions at the vertical flow brake 111c, the vertical flow brake can optionally be provided with a hole pattern through which water flows when the buoy 111 moves up and down (due to the swell on the sea surface). There and at the edges that are swept around at the outer radius of the vertical brake, the water usually swirls turbulently. The vertical flow brake 111c deliberately has a very small extension (thickness) in the vertical direction in order to offer only very little resistance to horizontal currents; in the horizontal direction, on the other hand, the extension is great in order to dampen the up and down movements of the long cylinder buoy 111. The horizontal currents for which the resistance is minimal due to the chosen shape are, e.g. tidal currents and local or regional currents.

The long cylinder buoy 111 is thus designed in such a way that movements of the buoy in the area of the sea surface are minimized. This is attained through the following measures:

1) The afore-mentioned pressure, friction and inertial forces are minimized or optimized in the horizontal direction over the entire length of the buoy. The optional choice of a round cross-section creates same conditions for pressure and frictional forces from all flow directions. It is also conceivable to reduce the diameter of the cylinder buoy 111 in the upper water layers in order to further minimize the area of attack for pressure and friction resistances as well as the displaced volume to reduce the inertial forces. The vertical flow brake 111c in the lower region has a minimum volume and thus minimum inertial forces (if these are still actually relevant in lower water layers). Moreover, as a result of the horizontal orientation, it offers a minimized area of attack for horizontal currents.

2) Minimization of resistance in vertical direction in the upper region of the buoy, i.e. in the area of relevant wave movement, through a smooth geometry and surface without discontinuous steps, edges and protruding functional components.

3) Maximization of resistance in vertical direction in the lower region of the buoy, i.e. in the area of the water layers which area is practically unaffected by the wave movement, e.g. by the flow brake described or several flow brakes.

Horizontally acting damping elements 111e (FIG. 9) in the lower region of the long cylinder buoy 111 are also conceivable, which virtually cause a clamping of the long cylinder buoy in practically still lower water layers. Horizontally acting damping elements can be advantageous in the absence of significant horizontal currents. In addition, the horizontally acting damping elements also dampen the rotation of the long cylinder buoy about its vertical axis.

As a result of the construction of the long cylinder buoy 111 (weight 111b in the lowermost region, buoyancy by the buoy tube 111a above the weight at all times), the long cylinder buoy always develops restoring forces when being deflected by external forces. As soon as it is tilted from the vertical, e.g. by horizontal forces in the upper, wave-affected region, such as, e.g., by horizontal forces of the connected PV array, it develops a restoring moment or a horizontal restoring force. Also in the vertical direction, the long cylinder buoy always strives for the balance of buoyancy and weight.

If the own alignment forces of the cylinder buoy 111 are not sufficient (e.g. along the edge of a PV unit), an essentially horizontally pulling traction means can in addition be attached to the upper end and connected to the bottom of the body of water, for example via deflection buoys (117 in FIG. 16) that are floating on the surface.

The module array 120 can be coupled to the array holder 110 in particular on the long cylinder buoy 111. In the embodiment of FIGS. 7 and 8, the coupling is realized, for example, via a running unit 111d, which is fixedly guided in the horizontal direction relative to the long cylinder buoy and is movable in vertical direction. The running unit 111d can hereby in particular also be designed as a downforce body (with fixed or variable downforce), i.e. it can have a sinking tendency. As an alternative, the running unit 111d can be designed as a buoyancy body (with fixed or variable buoyancy) or be adjustable between buoyancy and downforce. The running unit 111d can, for example, have the form of a hollow cylinder which surrounds the cylindrical buoy tube 111a with some play. The rotational mobility of the running unit 111d about the vertical axis of the buoy tube 111a is preferably eliminated or at least restricted (for example via restoring forces).

The attachment of the module array 120 to connection points of the running unit 111d (e.g. the eyelets that can be seen in FIG. 7) can be fixed, bendable, rotatable and/or flexible. A flexible connection reduces the deformation and stress of the components at the edge of the module array 120.

Furthermore, the long cylinder buoy 111 preferably includes mechanical stops at the upper (not shown) and lower end of the movement path of the running unit 111d.

The horizontal module array 120 is attached, e.g., via the running unit 111d. As a result, the force flow in the horizontal direction typically runs uninterrupted through array holder 110 and module array 120 (possibly with the exception of edge regions). Movement of the running unit 111d is possible in vertical direction. The vertical coupling of array holder and module array by means of the running unit 111d is preferably designed to be controllable, so that the axial forces (in direction of the longitudinal axis of the buoy) can be adjusted (permanently in advance by design measures and/or dynamically during operation).

The running unit 111d thus serves to couple horizontal and vertical forces between array holder 110 and module array 120, in horizontal direction with a complete transfer of the force flow of the horizontal forces in vertical direction, preferably with variable, adjustable properties.

This adjustability is realized e.g. via
1) mechanical components (form-fitting pairing of gears/racks, ball bearings, roller bearings, pressure rollers, etc.),
2) hydraulic components (pressure pads, hydraulic cylinders that press slide rails onto the running surfaces in a defined manner, etc.),
3) electrical components (linear motor, magnetic, inductive etc.) and/or
4) through variation of the buoyant force of the running unit 111d.

The adjustability leads in particular to the fact that the mobility of the module array is variable in relation to the array holder. In particular, due to the adjustability, the bearing in vertical direction can be continuously varied from practically resistance-free mobility to complete locking.

The free vertical mobility can be realized, e.g., in the normal operating state when operating the module array on the sea surface. In this context, FIG. 8 shows a central axial section through the running unit 111d. It is apparent that the running unit is in contact with the cylinder buoy via (e.g. twelve) rotatable guide rollers. The mobility of the running unit 111d can be varied by controlling the rotatability of these guide rollers.

Furthermore, for example by reducing the buoyancy force while being freely mobile, a sinking of the running unit 111d with the module array 120 into one of the positions already described (submerged position, etc.) can be realized. There, e.g. the running unit 111d can then be locked by fixation of the guide rollers.

A significant further advantage of the adjustable coupling forces in vertical coupling direction is that the hydroelastic behavior of the horizontal module array 120 can also be influenced. The wave parameters of the waves moving through the module array can be influenced by suitably adjusting the mobility. This results in a dissipation of wave energy when the up and down movements of the running unit 111d are slowed down by the wave movement as a result of the adjusted coupling forces. With the variable force control in vertical direction on a long cylinder buoy, several module arrays can also be influenced in their hydroelastic behavior when the long cylinder buoy is coupled with the module arrays at the same time. Also additional long cylinder buoys can be imagined within a horizontal module array as vertical guides. When several module arrays that are placed close to each other together form a larger continuous horizontal PV area (PV power plant 1000, FIGS. 13 to 16), there are thus a suitable number of long cylinder buoys within the overall area, which allow optimization of the hydroelastic behavior of the overall area by controlling the vertical coupling force on each long cylinder buoy. With appropriately adjusted vertical coupling forces, the wave movements can be dampened and thus significantly reduced inside the module arrays. The mobility (coupling strength) can hereby be the same on all cylinder buoys or can be adjusted individually on each cylinder buoy. In particular, the coupling conditions at the edge of the PV power plant or the PV unit may differ from those in the inner regions.

The described long cylinder buoy enables the guided lowering of module arrays to e.g. the protective position, with a simultaneous restoring effect.

Optionally, the long cylinder buoys 111 can also be designed to be lowered with the module array 120. When the cylinder buoy is sufficiently long (e.g. protrudes above the water by the stroke of the module array in the operating position), part of it remains at all times above the water surface when assuming the lowered position, while the array holder retains hereby its structure or shape. The horizontal positioning of the entire system can here be assumed by appropriate auxiliary buoys (e.g. the stabilization buoys 116, deflection buoys 117). In this case, the coupling of buoy holder 111h and buoy tube 111a is freely movable in the upper and lower regions in vertical direction (FIGS. 11, 12). Locking of the locking unit 111j is then released in the upper and lower regions.

FIG. 9 illustrates two alternative configurations of a long cylinder buoy 111, which, as in the previous embodiment, includes a buoy tube 111a with a weight 111b attached below it, as well as vertically acting and horizontally acting damping elements 111c, 111e. In the example illustrated on the left, three horizontally acting damping elements 111e are shown, which are distributed unevenly over the circumference (running vertically), while the example illustrated on the right has four horizontally acting damping elements 111e distributed evenly over the circumference. Of course, other numbers of horizontally acting and vertically acting damping elements with a different distribution and geometry can also be provided.

According to FIG. 10, a module array is coupled via a running unit 111f with an eyelet for attachment of the module array, with the running unit 111f being guided in a vertical linear guide 111g (undercut rail) on the surface of the buoy tube 111a. In the example illustrated on the left in FIG. 10, provision is made for only one linear guide 111g, while the example illustrated on the right has four linear guides 111g distributed evenly over the circumference, each with a running unit 111f.

The guided movement of a running unit along a cylinder buoy 111 or another guide element can also be implemented as forced guidance by means of chains, racks, form-fitting gears or the like.

FIG. 11 shows a further optional design of the foot region of a cylinder buoy 111. The lower stop position 115 for the running unit 111d is structurally designed in such a way that it shows a specific dynamic behavior, namely that of a buffer with damping properties and spring properties. Specifically, provision is made for a stop plate 111k for contact with the running unit 111d, which is connected to the buoy holder 111h and the locking unit 111j via damping elements 111m (shock absorbers with piston and cylinder) as well as via spiral springs 111n acting parallel thereto. Traction means (not shown) for anchoring the cylinder buoy 111 to the bottom of the body of water can be coupled to the buoy holder 111h. The locking unit 111j is intended for fixation of the stop position 115 at a selectable axial position of the buoy tube 111a, with this fixation capable of being implemented when the PV unit is set up (and then remains essentially unchangeable) or also being dynamically during operation of the PV unit. The impact of the running unit 111d when lowering the coupled module array (not shown) can thus take place in a dynamically optimized manner in order, for example, to avoid critical force loads and/or the development of vibrations.

In the upper region of the buoy (FIG. 12), the upper stop position can be designed in a same manner. The upper buoy holder 111h is located above the running unit 111d, the lower buoy holder 111h is located below the running unit 111d. The damping elements are located between the buoy holder 111h and the running unit 111d.

When the locking units 111j and thus the buoy holders 111h are adjusted for movement relative to the buoy tube, the entire long cylinder buoy 111 with the module array 120 can be lowered. The buoy holders 111h are hereby held in position, e.g., by their own buoyancy and/or via suitable stabilization buoys 116 and attachment means such as e.g. ropes in the lower region. In the upper region, the buoy holder 111h itself can be held in position by its buoyancy on the surface of the body of water and/or by stabilization buoys and/or deflection buoys 117 with suitable attachment means such as e.g. ropes.

When the locking units 111j and thus the buoy holders 111h are locked, the module array 120 can be moved vertically guided on the long cylinder buoys 111 by the movement of the running units 111d.

FIG. 12 shows the optional design of the upper end region of a cylinder buoy 111. The buoy holder 111h in connection with the locking unit 111j forms the upper stop position. The upper stop position 115 for the running unit 111d is hereby designed with the aid of one or more stop buffers (e.g. of rubber or a similar elastic material, springs, hydraulic buffers, etc.) in such a way as to display a specific dynamic behavior (damping and elasticity).

The stop positions (end stops), illustrated in FIGS. 11 and 12 can be used as a lower as well as an upper stop position, independently on the specific illustration in the exemplary drawings.

When the end stop in the end bearing is reached, the force acting there also causes a yielding/subsequent movement of the cylinder buoy in direction of the force, so that the end stop is further dampened here.

FIG. 13 shows a schematic representation of a PV power plant 1000 which is constructed from a plurality of PV units 100 of the type described above, which are coupled to one another via their side surfaces. This power plant 1000 is illustrated in FIG. 14 without PV modules (or with transparent PV modules) and without PV elements. FIG. 15 shows a top view and FIG. 16 a side view of this power plant 1000.

The electric energy generated by the power plant 1000 can be conducted ashore via electrical cables, not shown in detail, it can be stored on site (e.g. by generating “green hydrogen”), or it can be used in some other way.

As explained above, the individual PV units 100 of the power plant are comprised of module arrays 120 which can be displaced along the position buoys 111 of an array holder 110 between an operating position and (at least) a submerged position. The border-side position buoys 111 are hereby connected at their lower end to anchor points 113 on the bottom of the body of water via traction means 112a, with these traction means projecting outwards in the border region (pointing away from the surface of the module arrays). Position buoys located inside the power plant 1000 are only coupled to the horizontal bracing of the array holder 110 (internal traction means 114) at the level of the deepest submerged position in the illustrated embodiment. In addition or as an alternative, they could also be connected directly to the bottom of the body of water.

In the illustrated example, the position buoys 111 are also coupled in the border regions also at their upper end to anchor points 113 on the bottom of the body of water via traction means 112c, with these traction means 112c being guided via deflection buoys 117 floating on the water surface (outside the area of the PV modules), so that the corresponding traction forces act horizontally on the position buoys 111. The deflection buoys 117 can optionally be coupled to one another via a rope structure running about the power plant and/or a frame-like linkage made of, e.g., an elastic tube or the like (outer frame 118, FIG. 15).

The traction means 112a, 112c acting on the positioning buoys 111 run outwards from the area formed by the PV modules, preferably obliquely at an angle of at least 10°, particularly preferably at least 20°, at least 30°, at least 45°, or at least 60° in relation to the vertical.

At the level of the (deepest) submerged position, the array holder 110 can have internal traction means 114 which run essentially horizontally and can be coupled to the bottom of the body of water via separate traction means 112b.

As illustrated, two or more of the traction means 112a, 112b and/or 112c can be coupled to a common anchor point (weight 113) on the bottom of the body of water.

In the edge structure of a PV unit 100 or a PV power plant 1000, optional elements can be integrated very cost-effectively close to the surface as breakwater (not shown). In connection with the lowering of the module array when certain critical wave parameters are exceeded, these elements can replace classic very cost-intensive breakwaters that have a large vertical extent. This configuration enables PV power plants to be implemented safely and economically under offshore conditions.

With the described components, the entire PV unit 100 and a PV power plant 1000 can be optimized in such a way that the position of the PV unit is held securely, but wave movements vary the buoyancy as little as possible and lowest possible forces are introduced into the structure of the PV unit, thereby minimizing stress. Compared to other floating structures of the same size, a PV power plant has a very low dead weight and therefore inherently low system costs.

PV units 100 may be comprised of rectangular or square PV elements 130 and may have a rectangular or square extent. PV elements 130 can also have any other shape, such as hexagons (FIG. 6) or generally polygonal or round shapes, and overall can form PV units 100 of any size.

A PV unit 100 of the type described also has the following advantages during construction and installation, among others: The transport of the components, buoys and ropes, buoyancy bodies and the other components is possible with conventional means of transport (sea transport, truck, train, . . . ). Almost all components can be pre-fabricated or built, a quick and systematic assembly of the PV unit and the replacement of defective components is modularly possible.

### LIST OF REFERENCE SIGNS

100 PV unit
1000 PV power plant
110 array holder (“structure A”)
111 position buoy, long cylinder buoy
111a buoy tube
111b weight
111c vertically acting damping element, vertical flow brake
111e horizontally acting damping element
111d, f running unit
111g linear guide
111h buoy holder
111j locking unit
111k stop plate
111m shock absorber
111n spring elements
112, 112a, b, c traction means to the fixing point
113 weight
114 internal traction means
115 vertical limits
116 stabilization buoy
117 deflection buoy
118 outer frame, edge structure
120 module array (“structure B”)
121 Connections between PV elements
130 PV element
131 PV module
132 frame
133 retaining rope
135 downforce body
GB bottom of body of water or terrestrial ground
GO water surface
ST protection depth
LU air
WA water
G weight

What is claimed is:

1.-15. (canceled)

16. A PV unit for use on a body of water, the PV unit comprising:
a module array comprising at least one PV module; and
an array holder designed to move the module array between an operating position on a surface of the body of water and a submerged position below the surface of the body of water, said array holder comprising fixing means for coupling to a bottom and/or to the surface of the body of water,
wherein the module array is movable in a direction relative to the array holder.

17. The PV unit of claim 16, wherein the module array is movable relative to the array holder up to at least one stop position.

18. The PV unit of claim 16, wherein at least one of the module array and the array holder includes or is coupled with at least one of a buoyancy body and a downforce body with variable downforce.

19. The PV unit of claim 16, wherein the array holder includes a substantially vertically extending guide element, said module array being movably coupled to the guide element.

20. The PV unit of claim 19, wherein the guide element includes a movably mounted running unit, said module array connectable to the running unit.

21. The PV unit of claim 16, wherein a mobility of the module array relative to the array holder is variable.

22. The PV unit of claim 18, wherein the buoyancy body has an elongated shape, with a ratio of width to length being 1:2 or less.

23. The PV unit of claim 22, wherein the buoyancy body is designed to assume a substantially vertical orientation in water.

24. The PV unit of claim 16, further comprising a buoyancy body, said module array being movable along the buoyancy body.

25. The PV unit of claim 24, wherein the buoyancy body comprises a damping element for damping a movement thereof in water.

26. The PV unit of claim 18, wherein the buoyancy body is designed to assume a position below the surface of the body of water in an operating state.

27. The PV unit of claim 18, wherein the buoyancy body is designed to assume a position below the surface of the body of water at the submerged position or below.

28. The PV unit of claim 16, wherein the fixing means for direct or indirect coupling of the array holder to the bottom and/or on the surface of the body of water lies outside an area of the module array as viewed in a vertical direction.

29. A method for operating a PV unit, the method comprising shifting a module array with a PV module of the PV unit on a body of water between an operating position at a surface of the body of water and a submerged position below the surface of the body of water when a situation is encountered involving a swell and/or storm above a given strength, and/or for cleaning purposes, and/or for interruption or reduction of the electricity production, and/or at low solar radiation.

30. A module array for a PV unit, the module array comprising a plurality of PV elements which are elastically connected to each other, each of the PV elements carrying at least one PV module, the module array designed for movement by an array holder of the PV unit between an operating position on a surface of the body of water and a submerged position below the surface of the body of water wherein the module array is movable in a direction relative to the array holder.

31. The module array of claim 30, designed for movement relative to the array holder up to at least one stop position.

32. The module array of claim 30, further comprising a buoyancy body and/or a downforce body with variable downforce.

33. An array holder for a PV unit, the array holder designed to move a module array of the PV unit between an operating position on a surface of the body of water and a submerged position below the surface of the body of water, said array holder comprising fixing means for coupling to a bottom and/or to the surface of the body of water.

34. The array holder of claim 33, further comprising a substantially vertically extending guide element for guiding a movement of the module array.

35. The array holder of claim 34, wherein the guide element includes a movably mounted running unit designed for attachment of the module array.
